(19) United States
(12) Patent Application Publication
(10) Pub. No.: US 2013/0013527 A1
(43) Pub. Date: Jan. 10, 2013

(54) IMMIGRATION CONTROL SYSTEM

(75) Inventors: Osamu Takata, Sagamihara (JP); Yosuke Kaga, Yokohama (JP); Yoshiaki Isobe, Yokohama (JP); Takuya Kusunoki, Kawasaki (JP); Nobuo Takahashi, Tokyo (JP)

(73) Assignee: HITACHI, LTD., Tokyo (JP)

(21) Appl. No.: 13/428,044

(22) Filed: Mar. 23, 2012

(30) Foreign Application Priority Data
Jul. 8, 2011 (JP) 2011-151366

(51) Int. Cl. G06Q 99/00

(52) U.S. Cl. 705/325

(57) ABSTRACT

The present invention provides a system and a method for speeding up immigration. In first immigration, first biometric information is stored in a immigration biometric information DB. A normal immigration client terminal displays a first result of comparing an ID information watch list with a biometric information watch list. In subsequent second immigration, the first biometric information in the immigration biometric information DB is compared with second biometric information obtained by a simplified immigration client terminal. Then, the simplified immigration client terminal displays a second result of comparing the first biometric information with the watch list information that is added after the first comparison is done. Thus even if the number of registrations in a watch list database is large, a small amount of similar watch list information is displayed, reducing the time for checking the results by the operator.

### INCORPORATION BY REFERENCE

The present application claims priority from Japanese application serial No. 2011-151366, filed on Jul. 8, 2011, the entire contents of which are hereby incorporated by reference into this application.

### FIELD OF THE INVENTION

The present invention relates to an information processing technology for immigration. More particularly, the present invention relates to a technology capable of speeding up immigration based on personal authentication such as biometrics authentication.

### BACKGROUND OF THE INVENTION

Various technologies have been proposed to achieve smooth immigration control in airports or other transportation hubs. For example, JP-A No. 215999/2005 discloses a pre-immigration system. The pre-immigration system includes a shared controller for receiving passenger information input from a general-purpose terminal, as well as a advance passenger information database for storing the passenger information received from the general-purpose terminal or received by the shared controller. The shared controller determines whether the passenger information satisfies a predetermined condition. If the passenger information satisfies the predetermined condition, the shared controller stores the passenger information in the advance passenger information database. On the other hand, if the passenger information does not satisfy the predetermined condition, the shared controller transmits reception refusal information to the general-purpose terminal, without storing the passenger information in the advance passenger information database.

In Chapter 4 “System Architecture” of Privacy Impact Assessment Update for the US-VISIT Program, U.S. Department of Homeland Security, Jul. 1, 2005, a personal identification system is disclosed which uses a biometric information watch list database. In Chapter 1 “Introduction” of Privacy Impact Assessment Update for the US-VISIT Program, U.S. Department of Homeland Security, Jul. 1, 2005, “United States Visitor and Immigrant Status Indicator Technology (US-VISIT)” is described.

However, in the mechanism of the personal identification system disclosed in Privacy Impact Assessment Update for the US-VISIT Program, U.S. Department of Homeland Security, Jul. 1, 2005, a large number of similar watch list information is displayed as matching results when the number of registrations in the watch list database is large. In this case, it may take a long time for the operator to check the results.

Further, this system may require time for the entire personal identification process including watch list matching result display.

Thus, it is desirable to provide a system and a method for speeding up immigration to reduce the checking time by the operator even if, for example, the number of registrations in the watch list database is large and it takes a lot of time for matching result checking.

Further, it is also desirable to reduce the time for the entire immigration process including watch list matching result display.

### SUMMARY OF THE INVENTION

The present invention addresses the foregoing needs by providing a mechanism for determining whether the previous entry of a passenger to be examined satisfies a predetermined condition, and if the passenger to be examined satisfies the predetermined condition, comparing the personal information used for personal identification in the previous entry with the personal information obtained from the passenger to be examined. In this way, it is possible to verify the identity of the person who has entered the country (the passenger to be examined).

Further, the present invention also includes the following aspect. In the first immigration for the first entry into the country, personal identification is performed by comparing the watch list information stored in a so-called watch list database with the personal information input by the passenger to be examined. The personal information is registered. Then, in the second immigration in the subsequent entry, the identity of the passenger to be examined can be verified by comparing the personal information registered in the first immigration with the personal information input from the passenger to be examined in the second immigration.

In this aspect, the immigration system according to the present invention preferably includes: a immigration control information DB for storing immigration information including ID information and biometric information which are obtained from the user by a first terminal; a watch list database for storing watch list information; a matching server for comparing the immigration information with the watch list information of the watch list database; the first terminal for displaying a result of comparing with watch lists; and a verification server having a simplified immigration passenger to be examined matching function for comparing the biometric information in the immigration information DB with the biometric information obtained by a second terminal to determine whether these biometric information pieces are of the same person. In the first immigration, the first biometric information is stored in the immigration information DB. The matching server compares the first biometric information with the first watch list information. The first terminal displays a result of comparing the first biometric information with the first watch list information. In the subsequent second immigration, the simplified immigration passenger to be examined matching function compares the first biometric information in the immigration information DB with the second biometric information obtained by the second terminal. The matching server compares with the second watch list information other than the first watch list information in the watch list database. Then, the second terminal displays a result of comparing with the second watch list information.

Still further, in this aspect, the present invention also includes a configuration in which either comparing with the watch list information or comparing with the second watch list information can be selected in the second immigration, according to the input of the operator (immigration control officer).

As described above, the present invention facilitates the immigration process including personal verification in the second immigration by using the previous immigration (first immigration) result.

According to the present invention, it is possible to reduce the amount of work or time for immigration by facilitating the personal verification by using the result of the previous immigration (the first immigration).

### BRIEF DESCRIPTION OF THE DRAWINGS

FIG. 1 is a block diagram of a immigration system according to an embodiment of the present invention;

FIG. 2 is a block diagram of a normal immigration client terminal 60 and a simplified immigration client terminal 70 according to an embodiment;

FIG. 3 is an example of an ID information watch list 51 according to an embodiment;

FIG. 4 is an example of a biometric information watch list 52 according to an embodiment;

FIG. 5 is an example of immigration information 53 according to an embodiment;

FIG. 6 is an example of an ID information watch list matching result 54 according to an embodiment;

FIG. 7 is an example of a biometric information watch list matching result 55 according to an embodiment;

FIG. 8 is an example of immigration biometric information 56 according to an embodiment;

FIG. 9 is an example of the normal immigration process sequence for the first entry into the country, according to an embodiment (part 1);

FIG. 10 is an example of the normal immigration process sequence for the first entry into the country, according to an embodiment (part 2);

FIG. 11 is an example of the normal immigration process sequence for the first entry into the country, according to an embodiment (part 3);

FIG. 12 is an example of the simplified immigration process sequence for reentry into the country after the normal immigration process has been completed in the first entry, according to an embodiment (part 1);

FIG. 13 is an example of the simplified immigration process sequence for reentry into the country after the normal immigration process has been completed in the first entry, according to an embodiment (part 2);

FIG. 14 is an example of the simplified immigration process sequence for reentry into the country after the normal immigration process has been completed in the first entry, according to an embodiment (part 3);

FIG. 15 is a view of a screen displayed on the normal immigration client terminal 60 in the normal immigration process for the first entry, according to an embodiment;

FIG. 16 is a view of a screen displayed on the simplified immigration client terminal 70 in the simplified immigration process for reentry, according to an embodiment; and

FIG. 17 is a block diagram of a hardware configuration of each device in the immigration system according to an embodiment.

### DETAILED DESCRIPTION OF THE PREFERRED EMBODIMENTS

Hereinafter, preferred embodiments of the present invention will be described in detail with reference to the accompanying drawings.

In the following description, the term “ID information” refers to the identifier information such as passport number and identity (ID) card number, as well as the identity information indicated in the passport or ID card, such as nationality, name, sex, and date of birth. Further, similar to the description of U.S. Department of Homeland Security, the term “watch list” refers to the “the “No Fly” list includes individuals who are prohibited from boarding an aircraft”, or the “the “Selectee” list includes individuals who must undergo additional security screening before being permitted to board an aircraft”.

Further, the term “immigration control” means the inspection performed by an immigration officer with the support of an immigration control system in the entry airport when the passenger enters the country.

First and second embodiments show an example of an immigration system for foreigners in an internal airport. Note that this is an example of an international airport, but the immigration system can also be applied to the border gate of an international sea port or a road.

Immigration control has two axes: “strictness” and “smoothness”. The embodiments can achieve the effect of “smoothness” while keeping “strictness”.

### First Embodiment

A first embodiment shows an example in which a normal immigration process is performed in the first entry, and a simplified immigration process is performed in the second and subsequent entries. In the normal immigration process, ID information and biometric information are obtained and stored. In the simplified immigration, ID information and biometric information are obtained again to compare with the stored biometric information.

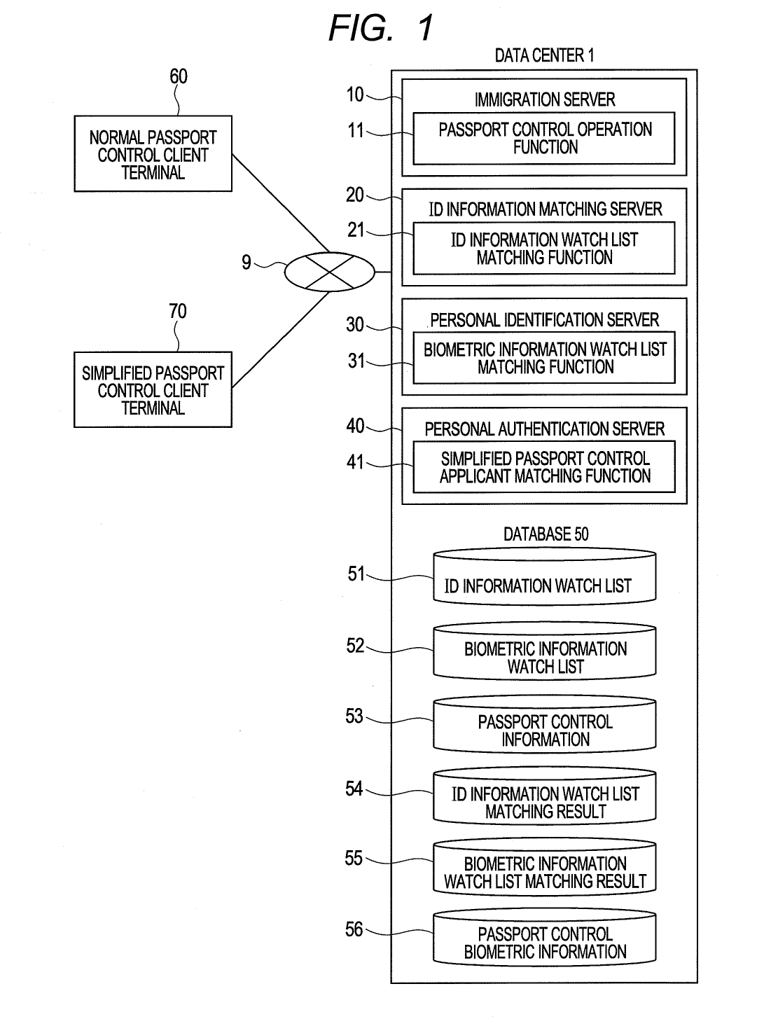

FIG. 1 shows the configuration of a immigration system.

The immigration system includes a data center 1, a normal immigration client terminal 60, and a simplified immigration client terminal 70, which are connected to each other by a network 9. These components are realized by a so-called computer, and execute each process (function, and the like, described below) by a processor such as a CPU according to a program.

The data center 1 includes an immigration server 10, an ID information matching server 20, a personal identification server 30, a verification server 40, and a database (DB) 50. The DB 50 includes the following databases: ID information watch list 51, biometric information watch list 52, immigration information 53, ID information watch list result 54, biometric information watch list matching result 55, and immigration biometric information 56.

Note that the immigration information 53 and the ID information watch list matching result 54 may be a single integrated DB, or may be two separate DBs.

Next, the configuration of the data center 1 will be described in detail.

The immigration server 10 has a immigration operation function 11. The immigration operation function 11 manages the immigration operation. In other words, the immigration operation function 11 performs information processing to achieve the immigration operation, by using the functions of the ID information matching server 20, the personal identification server 30, and the verification server 40 as well as using the various information of the DB 50, in collaboration with the normal immigration client terminal 60 and the simplified immigration client terminal 70.

The ID information matching server 20 has an ID information watch list matching function 21. The ID information watch list matching function 21 searches for data matching or similar to specific ID information that is obtained by an ID information acquisition function 602, from the data in the ID information watch list 51, or from the data with a certain number and the following numbers of the ID information watch list update serial number in the ID information watch list 51.

The personal identification server 30 has a biometric information watch list matching function 31. The biometric information watch list matching function 31 determines whether the biometric information matching the specific biometric information that is obtained by a finger vein & fingerprint & facial biometric information acquisition function 610, or stored in the immigration biometric information 56, is present in the biometric information watch list 52, or present in the data with a certain number and the following numbers of the biometric information watch list update serial number in the biometric information watch list 52. Here, the finger vein & fingerprint & facial biometric information are mentioned. However, the configuration using at least one of the three types of biometric information is also included in this embodiment (as described below).

The verification server 40 has a simplified immigration passenger to be examined matching function 41. The simplified immigration passenger to be examined matching function 41 compares the biometric information in the immigration biometric information 56 with the biometric information obtained by the finger vein & fingerprint & facial biometric information acquisition function 610. Then, the simplified immigration passenger to be examined matching function 41 determines whether these biometric information pieces are of the same person.

Note that, for example, the simplified immigration passenger to be examined matching function 41 can use a multimodal biometrics (for example, a plurality of types of biometric information such as facial, fingerprint, and finger vein) that are obtained by the finger vein & fingerprint & facial biometric information acquisition function 610. In this case, even if the acquisition quality of one of a plurality of types of biometric information is low due to the influence of the environment, it is possible to achieve more accurate matching and determination results as a whole if the acquisition quality of the other biometric information is high. Further, even if one type of biometric information is intentionally altered, it is possible to achieve accurate determination if the other biometric information can be normally obtained.

Note that, for example, the simplified immigration passenger to be examined matching function 41 can use one of the modals (for example, the facial, fingerprint, and finger vein information) obtained by the finger vein & fingerprint & facial biometric information acquisition function 610.

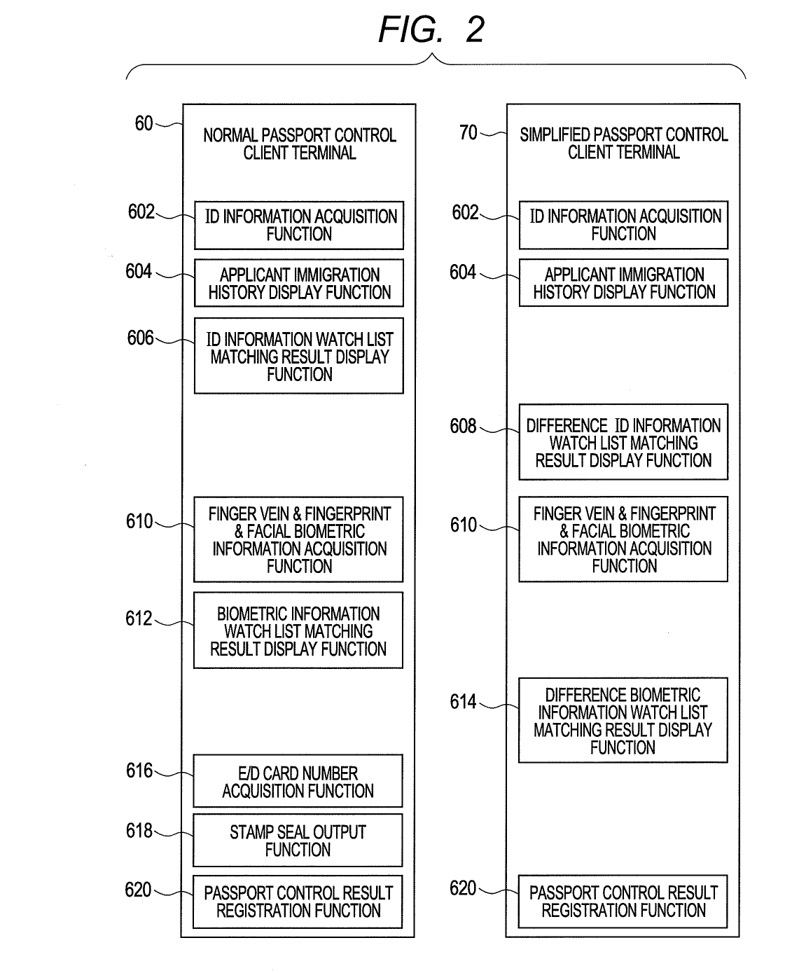

FIG. 2 shows the functional configuration of the normal immigration client terminal 60 and the simplified immigration client terminal 70.

The normal immigration client terminal 60 and the simplified immigration client terminal 70 may be different terminal devices as shown in FIG. 1, or may be a single terminal having both functions of the normal immigration client terminal 60 and the simplified immigration client terminal 70. It is also possible to use a terminal having a function that encompasses the normal immigration client terminal 60 and the simplified immigration client terminal 70 to serve as the normal immigration client terminal 60 and the simplified immigration client terminal 70, respectively. In other words, each client terminal can be realized by changing the application (program) that can be used for the operation of the particular client terminal, according to the required operation (immigration). It is also possible to realize by changing the program to be activated according to the need of the operation.

The normal immigration client terminal 60 includes ID information acquisition function 602, immigration history display function 604, ID information watch list matching result display function 606, finger vein & fingerprint & facial biometric information acquisition function 610, biometric information watch list matching result display function 612, embarkation/disembarkation card number acquisition function 616, stamp seal output function 618, and immigration result registration function 620. The simplified immigration client terminal 70 includes ID information acquisition function 602, immigration history display function 604, difference ID information watch list matching result display function 608, finger vein & fingerprint & facial biometric information acquisition function 610, difference biometric information watch list matching result display function 614, and immigration result registration function 620. It is enough that the finger vein & fingerprint & facial biometric information acquisition function 610 can handle at least one type of the biometric information as described above.

The ID information acquisition function 602 is the function to obtain the ID information of the passenger from the passport, ID card, visa, or certificate of the passenger by using a passport reader, a card reader, or a bar code reader.

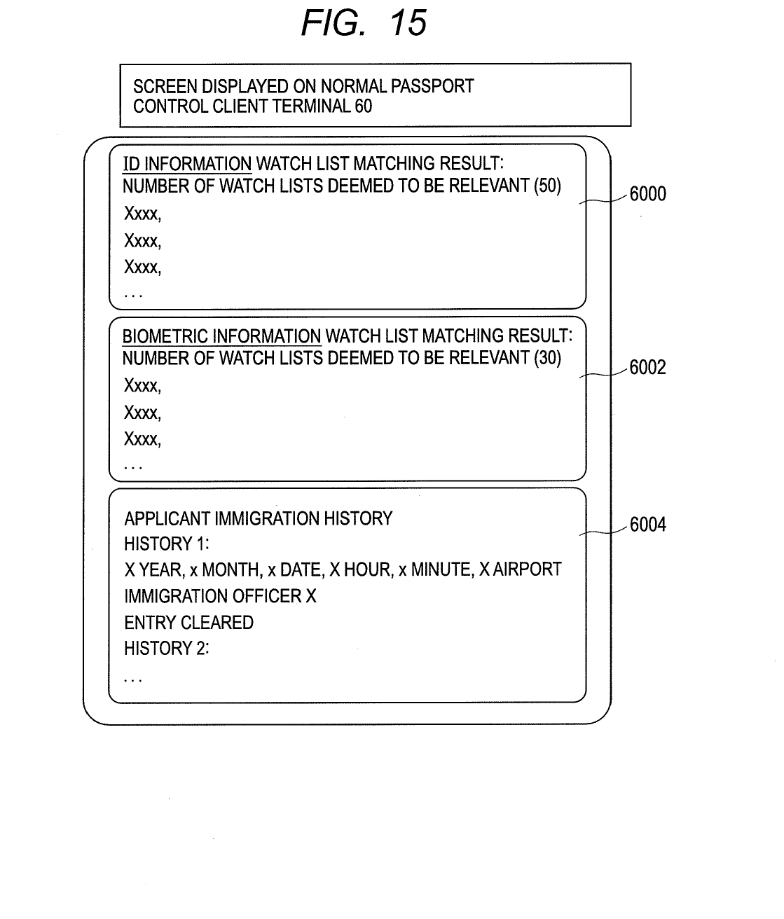

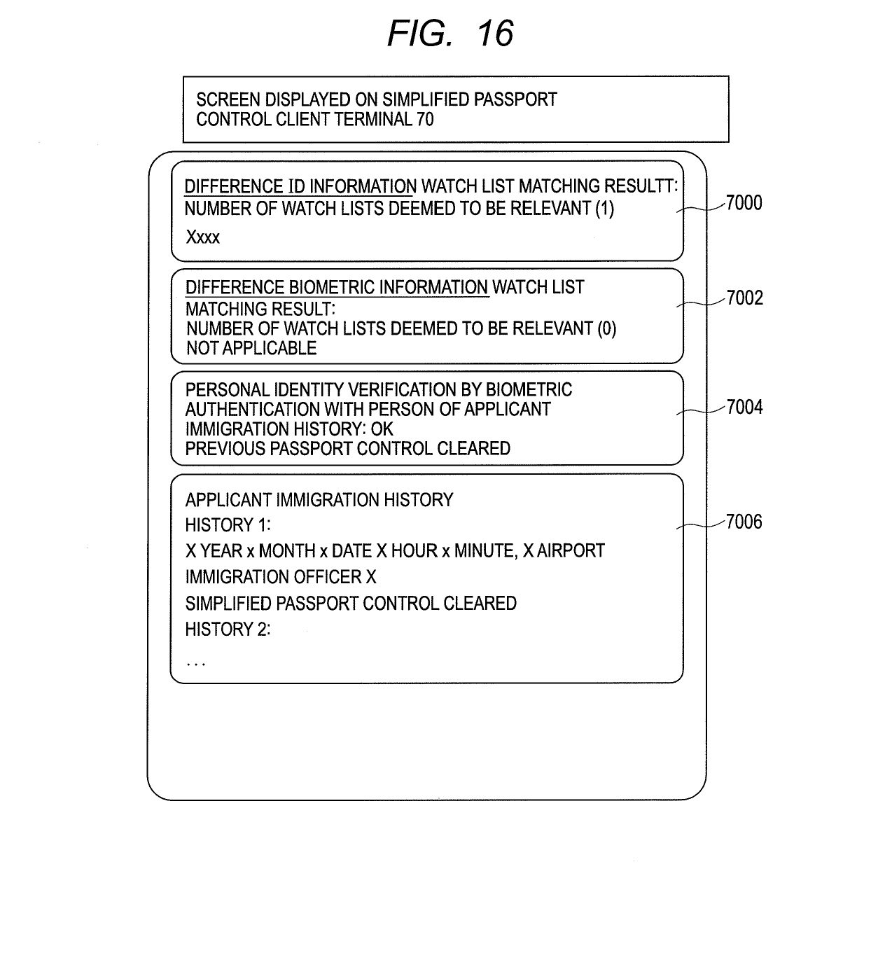

The immigration history display function 604 is the function to display the corresponding immigration history information in the immigration information 53. The normal immigration client terminal 60 displays the immigration history information as shown in an immigration history window of FIG. 15. The simplified immigration client terminal 70 displays the immigration history information as shown in an immigration history window of FIG. 16.

The ID information watch list matching result display function 606 is the function to display the results of searching by the ID information watch list matching function 21, as shown in an ID information watch list matching result window of FIG. 15. The difference ID information watch list matching result display function 608 is the function to display the results of searching for a portion of the data by the ID information watch list matching function 21, as shown in an ID information watch list matching result window of FIG. 16.

The finger vein & fingerprint & facial biometric information acquisition function 610 includes, for example, a camera for taking facial images, a sensor for obtaining fingerprint and finger vein information, and a signal processing function of the information obtained by the camera and the sensor. The function obtains a plurality of types of biometric information (facial image, fingerprint, finger vein) from the passenger.

Note that if the finger vein & fingerprint & facial biometric information acquisition function 610 is designed to obtain the fingerprint and finger vein information by a single sensor at the same time, the number of operations performed by the user can be reduced compared to the case of obtaining the fingerprint and finger vein information by two different sensors.

The biometric information watch list matching result display function 612 is the function to display the result of matching by the biometric information watch list matching function 31 on a biometric information watch list matching result window of FIG. 15. The difference biometric information watch list matching result display function 614 is the function to display the result of matching with a portion of the data by the biometric information watch list matching function 31 on a difference biometric information watch list matching result window of FIG. 16.

The embarkation disembarkation card number acquisition function 616 is the function to obtain the embarkation disembarkation card number by means of the bar cord reader and the like.

The stamp seal output function 618 is the function to print a stamp seal. This is done by transmitting an instruction to print the stamp seal to a printer not shown.

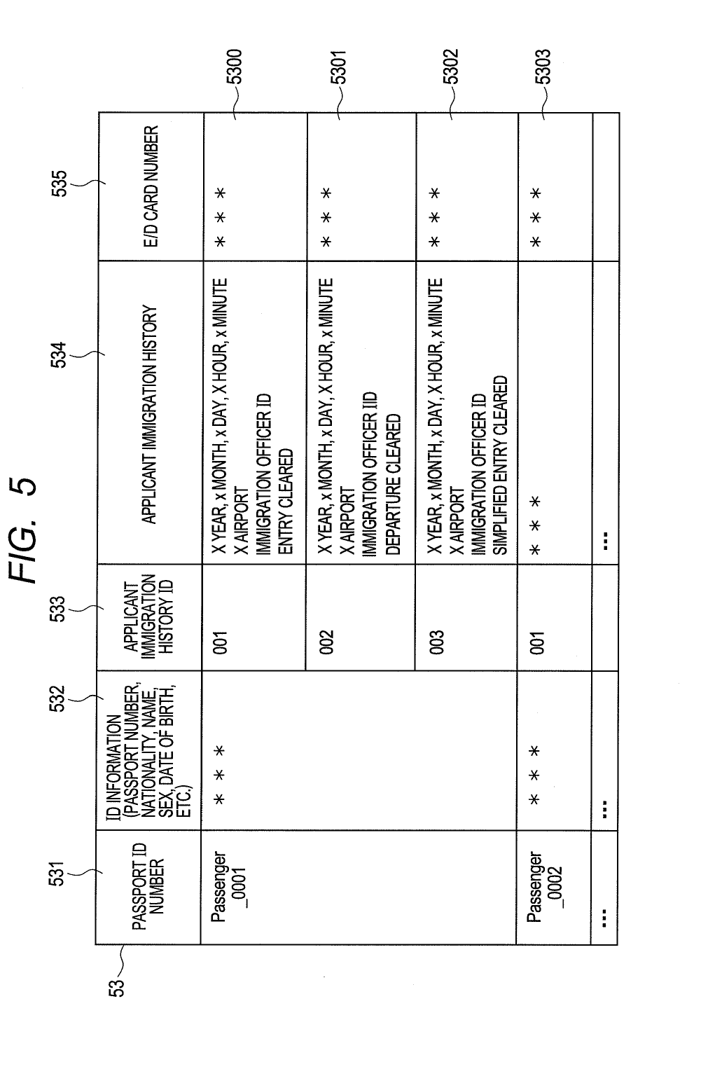

The immigration result registration function 620 is the function to register the immigration result in an immigration history 534 of the immigration information 53 shown in FIG. 5.

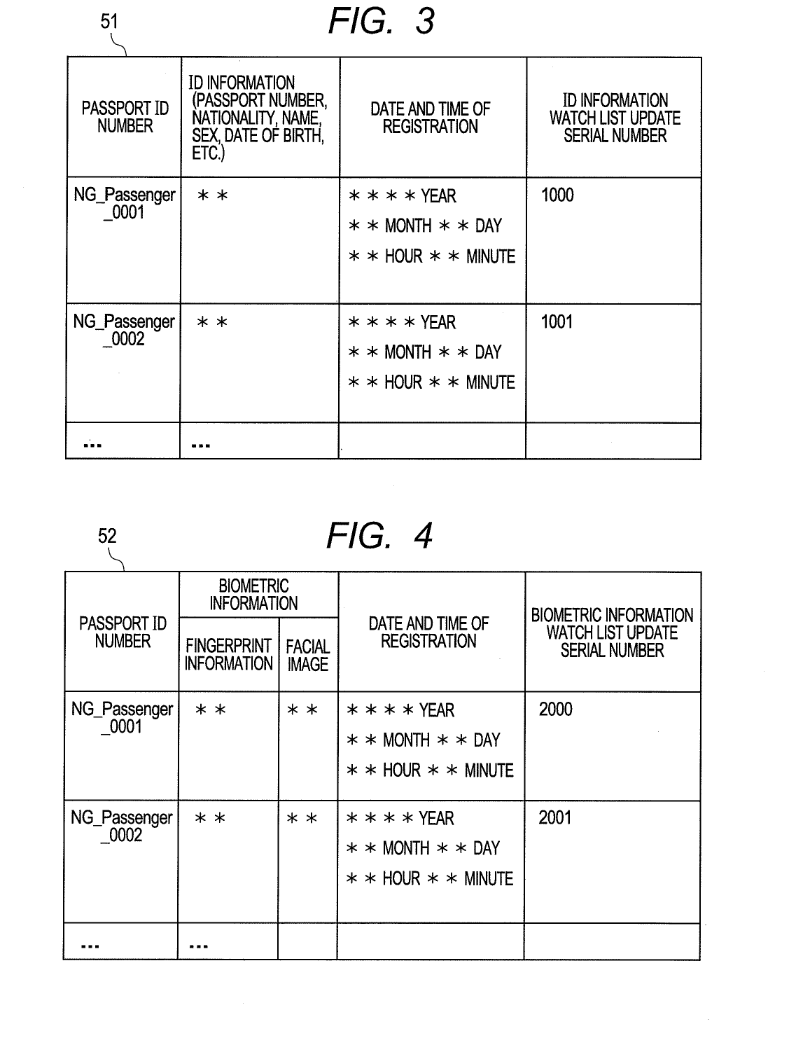

FIG. 3 is an example of the ID information watch list 51.

The ID information watch list 51 includes the ID information (such as passenger identification number, passport number, nationality, and name), the registration date and time, and the ID information watch list update serial number. The ID information watch list 51 stores the ID information of suspicious persons. Note that the ID information watch list 51 is typically updated by adding or deleting information at an arbitrary timing. When new data is added to the ID information watch list 51, a number is assigned to the new data. This number is obtained by adding one to the maximum value of the ID information watch list serial number in the ID information watch list 51 (for example, 1001 in the example of FIG. 3). Also, when the information recorded in the ID information watch list 51 is updated, a number is assigned to the updated data. This number is obtained by adding one to the maximum value of the ID information watch list update serial number in the ID information watch list 51. For example, when the content of NG_Passenger 0002 is updated, 1002 is assigned to the updated data.

Note that the ID information watch list 51 may be a list for denied entry and ordered to leave, as well as a watch list obtained from abroad. These lists can be stored in the same database 51 as shown in this embodiment or stored in different databases. When the lists are stored in different databases, the ID information watch list update serial number is assigned to each database, separately. The ID information watch list update serial number is enough to identify the watch lists from each other. It can be realized by “serial” or “random”, “number” or “(number+) symbol”, and the like.

FIG. 4 is an example of the biometric information watch list 52.

The biometric information watch list 52 includes, similarly to the ID information watch list 51, the passenger identification number, the biometric information (fingerprint information and facial image information), the registration date and time, and the biometric information watch list update serial number. The biometric information watch list 52 stores the biometric information of suspicious persons. Note that the biometric information watch list 52 is updated accordingly by adding or deleting information at an arbitrary timing. When new data is added to the biometric information watch list 52, a number is assigned to the new data. This number is obtained by adding one to the maximum value of the biometric information watch list update serial number in the biometric information watch list 52 (for example, 2001 in the example of FIG. 4). Also, when the information stored in the biometric information watch list 52 is updated, a number is assigned to the updated data. This number is obtained by adding one to the maximum value of the biometric information watch list update serial number in the biometric information watch list 52. For example, when the content of NG_Passenger 0002 is updated, 2002 is assigned to the updated data.

Note that the biometric information watch list 52 may be a list for deportation as well as a watch list obtained from abroad. These lists can be stored in the same database as described in this embodiment, or stored in different databases. When the lists are stored in different databases, the ID information watch list update serial number is assigned to each database, separately.

FIG. 5 shows an example of the immigration information 53.

The immigration information 53 includes a passenger identification number 531, ID information 532, immigration history ID 53, immigration history 534, and embarkation disembarkation card number 535.

Note that, as shown in FIG. 5, a plurality of records (5300 to 5302) can be recorded with respect to the same passenger. In this case, a different immigration history ID is assigned to each record.

Note that it is also possible to record “entry not permitted” in the immigration history 534 in such a way that the ID information watch list and the biometric information watch list, which are the cause of this result, can be identified.

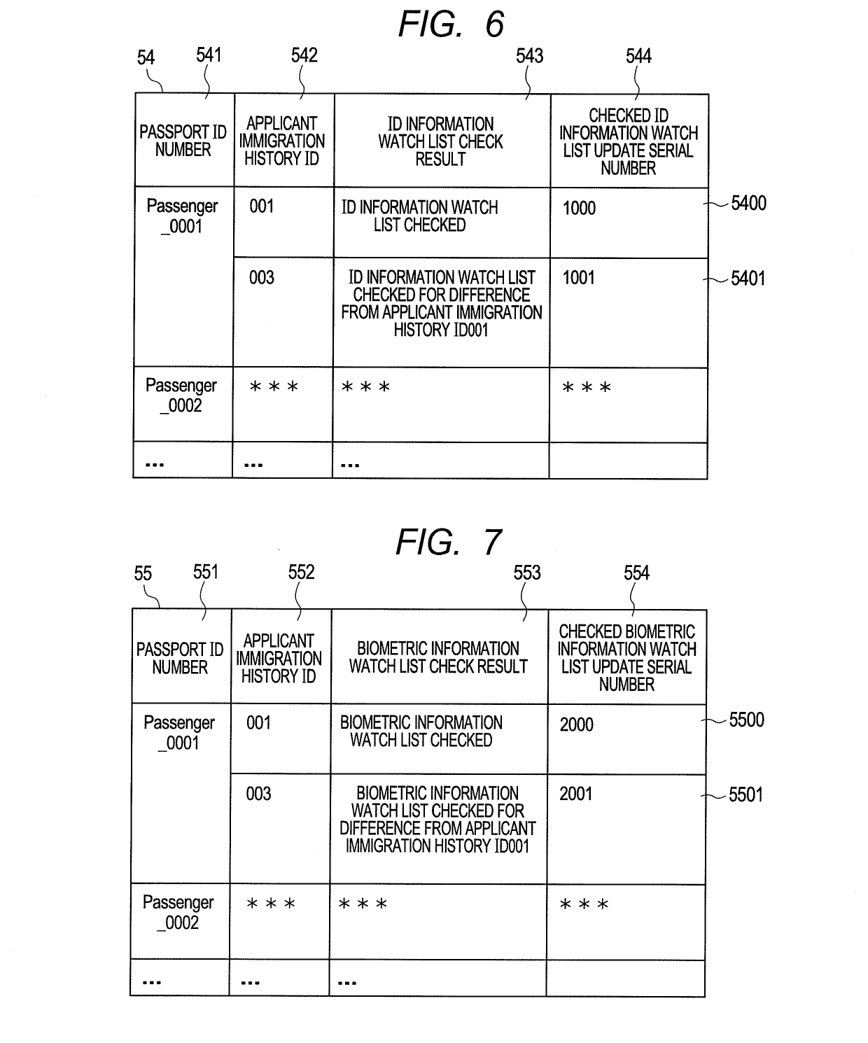

FIG. 6 is an example of the ID information watch list matching result 54.

The ID information watch list matching result 54 includes passenger identification number 541 and immigration history ID 542 which are in common with the items of the immigration information 53, ID information watch list check result 543, and checked ID information watch list update serial number 544.

FIG. 7 is an example of the biometric information watch list matching result 55.

The biometric information watch list matching result 55 includes the immigration information 53, passenger identification number 551, immigration history ID 552, biometric information watch list check result 553, and checked biometric information watch list update serial number 554.

Note that in the biometric information watch list matching result 55, the passenger identification number 551 and the immigration history ID 552 may be or may not be common to the immigration information 53. For example, when the passenger identification number 551 and the immigration history ID 552 are not common to the immigration information 53, the immigration information 53 can manage information that associates the immigration history ID 552 with the immigration history ID 533 to establish the correspondence between these data pieces.

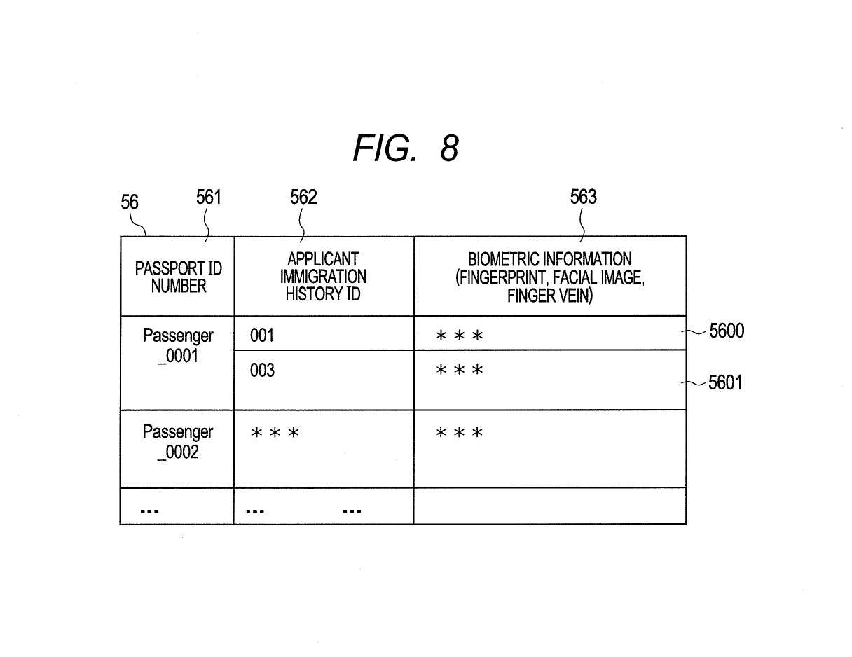

FIG. 8 is an example of the immigration biometric information 56.

The immigration biometric information 56 includes the immigration information 53, common passenger identification number 561, immigration history ID 562, and biometric information (fingerprint, facial image, finger vein) 563 recorded at the time of immigration inspection.

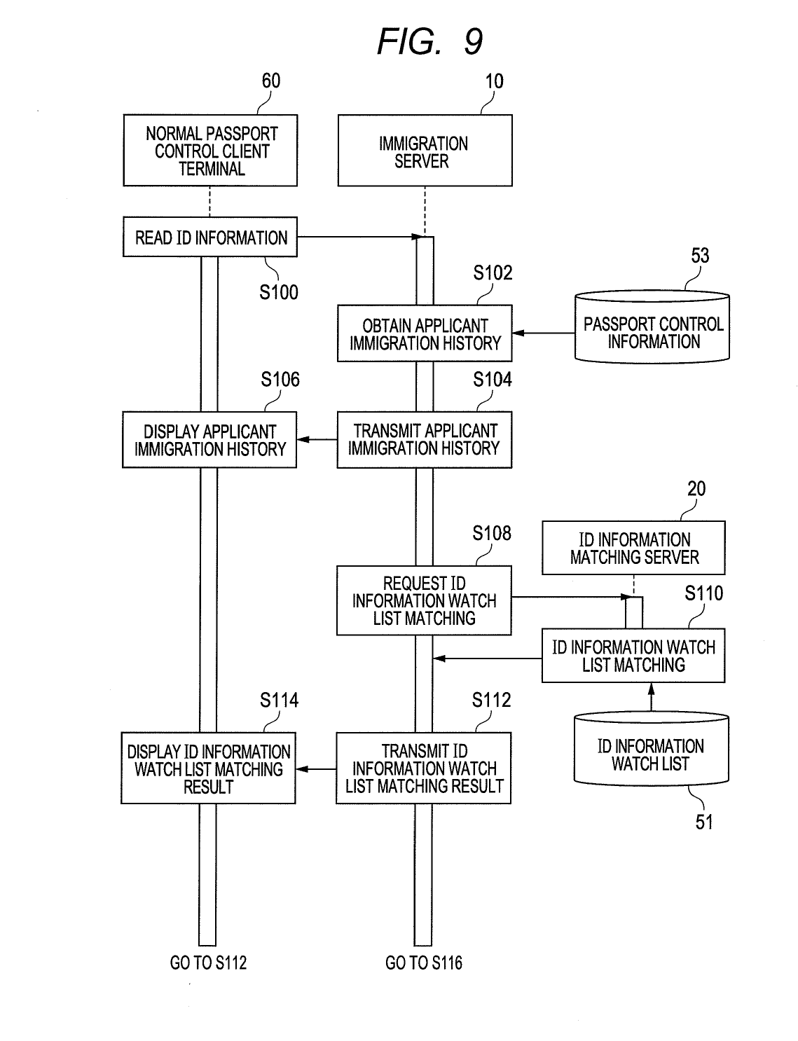

FIGS. 9, 10, and 11 are views showing a series of immigration sequences for the first entry of a passenger.

First, the immigration process (part 1) will be described with reference to the sequence of FIG. 9.

The normal immigration client terminal 60 obtains ID information by the ID information acquisition function 602. Then, the normal immigration client terminal 60 transmits the obtained ID information to the immigration server 10 (S100).

The immigration server 10 searches for the ID information 532 in the immigration information 53, using the ID information obtained in S100 as the key. If the corresponding data is found, the immigration server 10 obtains the immigration history 534 corresponding to the particular data. If the corresponding data is not found, the immigration server 10 adds a new row (for example, 5303 of FIG. 5) to record the immigration history in the immigration information 53 (S102). The immigration server 10 transmits the data obtained in S102 to the normal immigration client server 60 (S104). Then, the normal immigration client terminal 60 displays the data (S104).

The immigration server 10 transmits the ID information received in S100, as well as a watch list matching request to the ID information matching server 20 (S108). The ID information matching server 20 searches for the data matching or similar to the received ID information received from the immigration server 10, from the data in the ID information watch list 51. Then, the ID information matching server 20 responds to the immigration server 10 with the result (S110). The immigration server 10 transmits the result to the normal immigration client terminal 60 (S112). Then, the normal immigration client terminal 60 displays the result (S114). Note that the result that is responded to the immigration server 10 in S110, transmitted to the normal immigration client terminal 60 in S112, and displayed in S114, may be the presence of the matching or similar information, or may be the information list of the ID information watch list 51 with high similarity.

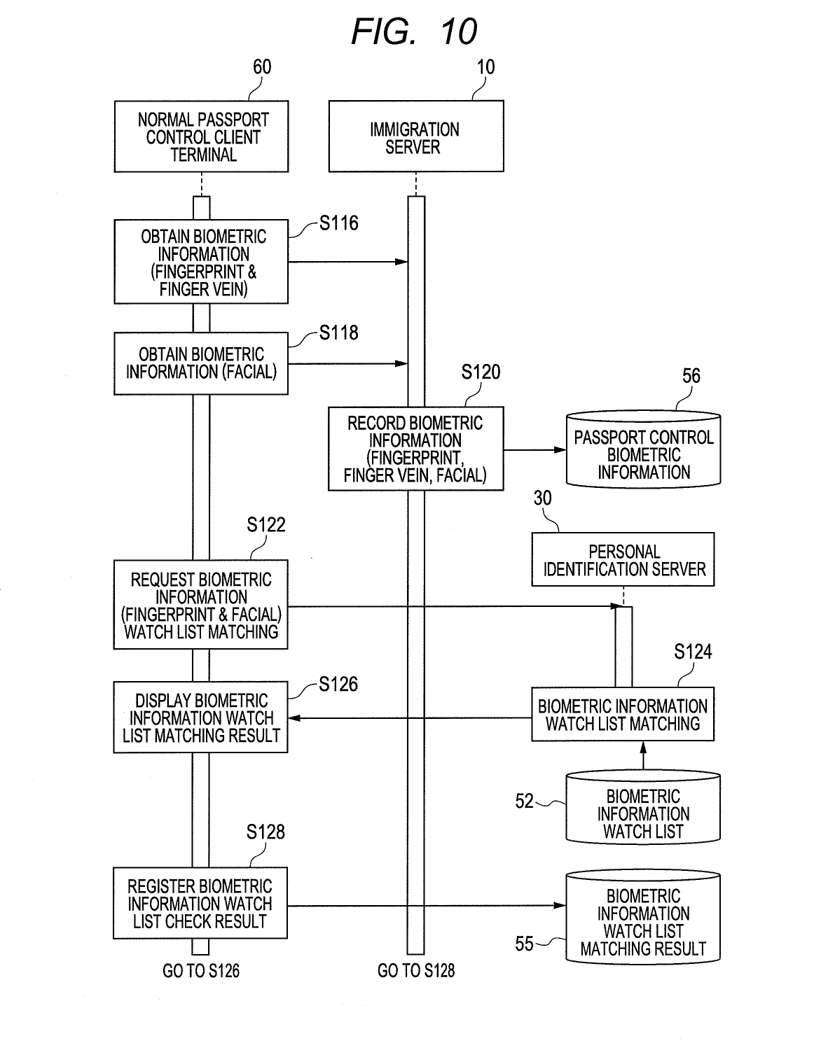

Next, the immigration process (part 2) will be described with reference to the sequence of FIG. 10.

The normal immigration client terminal 60 obtains the fingerprint and finger vein information by the finger vein & fingerprint & facial biometric information acquisition function 610, and transmits it to the immigration server 10 (S116). Then, the normal immigration client terminal 60 obtains the facial information by the finger vein & fingerprint & facial biometric information acquisition function 610, and transmits to the immigration server 10 (S118). The immigration server 10 records the obtained information in the column (the column of the biometric information 563 & 5600 in FIG. 8) of the immigration biometric information 56 corresponding to the passenger identification number and the immigration history ID for the present inspection (S120).

The normal immigration client terminal 60 transmits the fingerprint and facial biometric information obtained in S116 and S118, as well as a watch list matching request to the personal identification server 30 (S122). Then, the personal identification server 30 compares the received biometric information with the biometric information in the biometric information watch list 52 to determine whether there is the biometric information matching or similar to the received biometric information. Then, the personal identification server 30 responds to the normal immigration client terminal 60 with the result (S124). The normal immigration client terminal 60 displays the result (S126). Note that the result responded to the normal immigration client terminal 60 may be the presence of the matching or similar information, or may be the information list of the biometric information watch list 52 with a similarity higher than a predetermined value.

The operator of the normal immigration client terminal 60 determines whether the passenger is relevant to the biometric information watch list based on the information displayed in S126. Then, the operator can input the determination result into the normal immigration client terminal 60. The normal immigration client terminal 60 stores the determination result in the column (for example, the column of 553 & 5500) corresponding to the passenger identification number and the immigration ID for the present inspection. Further, the normal immigration client terminal 60 stores the maximum value of the checked biometric information watch list update serial number in the data that is checked in S124 in the column (554 & 5500) (S128).

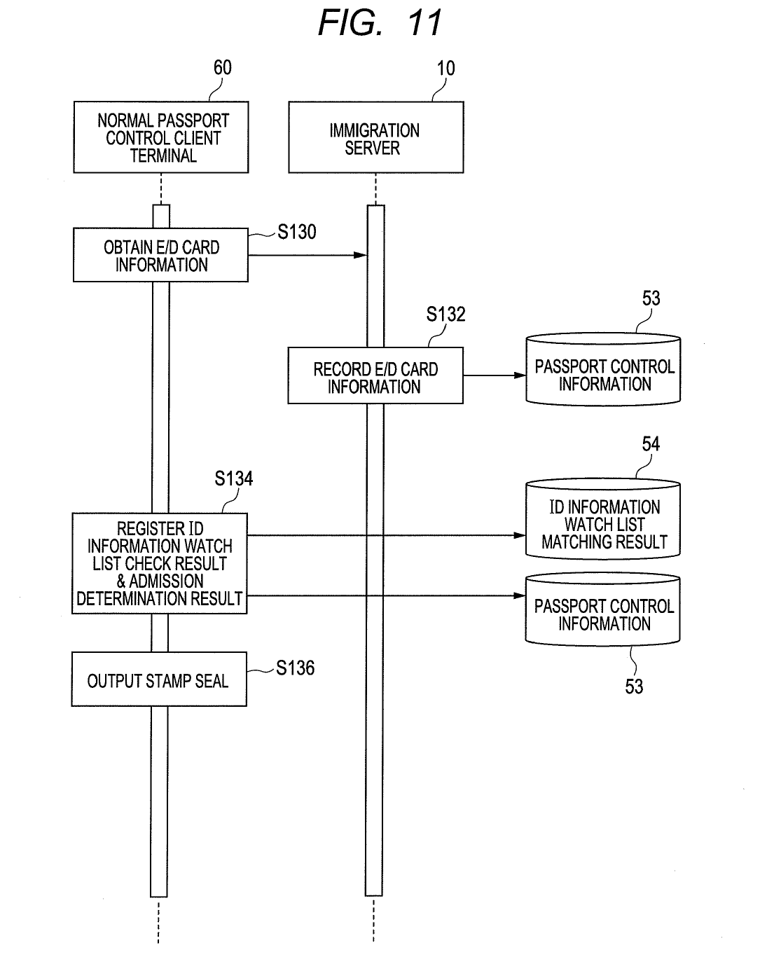

Next, the immigration process (part 3) will be described with reference to the sequence of FIG. 11.

The normal immigration client terminal 60 obtains an embarkation/disembarkation (E/D) card number by an E/D card number acquisition function 616, and transmits it to the immigration server 10 (S130). The immigration server 10 registers the E/D card number in the column (535 & 5300) corresponding to the passenger identification number and the immigration history ID in the immigration information 53 for the present inspection (S132).

Generally, the operator of the normal immigration client terminal 60 determines whether the passenger is relevant to the watch list based on the information displayed in S114. Further, the operator determines whether entry permission is granted from a comprehensive perspective by taking into account the other inspection operation. Then, based on the input content according to the determination, the normal immigration client terminal 60 performs the following steps:

(1) Record the determination result in the column (543 & 5400) of the ID information watch list matching result 54 corresponding to the passenger identification number and the immigration history ID for the present inspection;
(2) Record the maximum value of the checked ID information watch list update serial number in the data that is checked in S110, into the column (544 & 5400) of the ID information watch list matching result 54 corresponding to the passenger identification number and the immigration history ID for the present inspection; and
(3) Record the immigration determination result in the column (534 & 5300) of the immigration information 53 corresponding to the passenger identification number and the immigration history ID for the present inspection (S134).

The normal immigration client terminal 60 prints a stamp seal by the stamp seal output function 618, and then ends the process (S136).

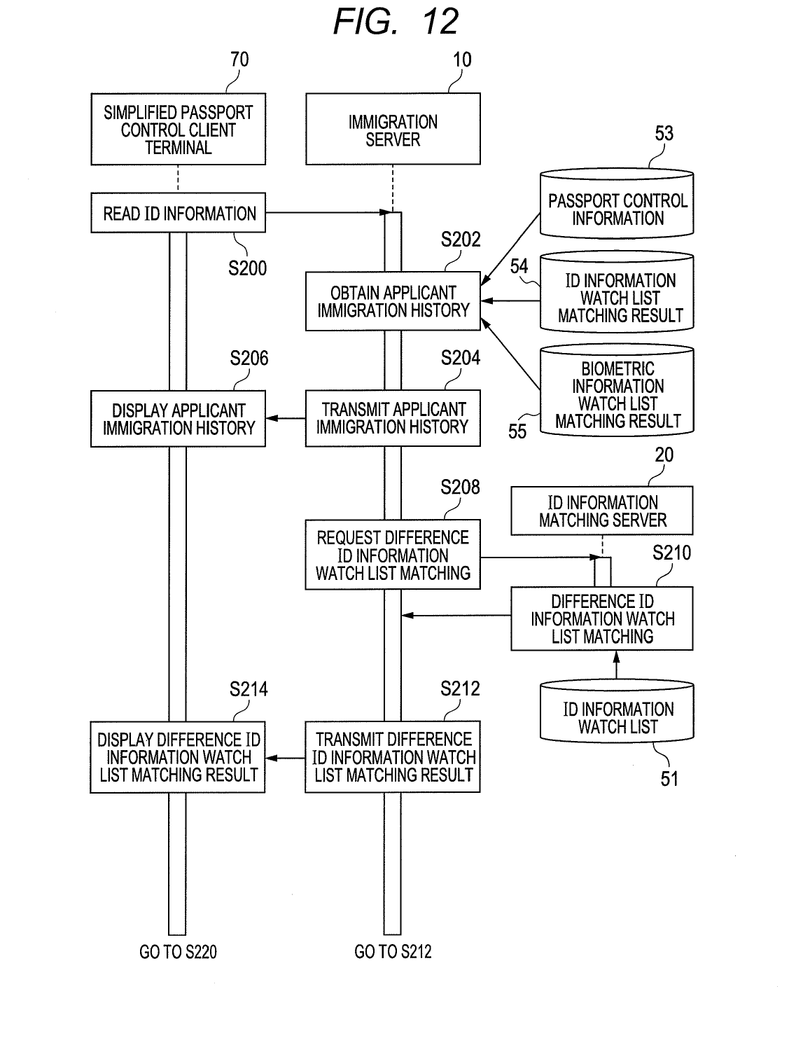

FIGS. 12, 13, and 14 show the immigration process sequences in the case in which the passenger undergoes the first entry according to the sequence shown in FIGS. 9 to 11, leaves the country, and then reenters the country.

In the sequences from FIG. 12 to FIG. 14, the entire process time is generally shorter than the time of the sequences from FIG. 9 to FIG. 11, so that it is possible to reduce the time for the entire immigration process.

Here, the process of FIGS. 9 to 11 is performed one or more times. For example, 5300 and 5301 are recorded in the immigration information 53, 5400 is recorded in the ID information watch list matching result 54, 5500 is recorded in the biometric information watch list matching result 55, and 5600 is recorded in the immigration biometric information 56.

First, the simplified immigration process (part 1) will be described with reference to the sequence of FIG. 12.

The simplified immigration client terminal 70 obtains ID information by the ID information acquisition function 602, and transmits to the immigration server 10 (S200).

The immigration server 10 searches for the ID information 532 in the immigration information 53, using the ID information obtained in S200 as the key. If the corresponding data is found, the immigration server 10 obtains the corresponding immigration history 534. Then the immigration server 10 also obtains the corresponding checked ID information watch list update serial number 544 (1000 in this example) of the ID information watch list matching result 54, and obtains the corresponding checked biometric information watch list update serial number 554 (2000 in this example) of the biometric information watch list matching result 55 (S202). The immigration server 10 transmits the data obtained in S202 to the normal immigration client terminal 60 (S204). Then, the normal immigration client terminal 60 displays the received data (S206).

Note that the process from S100 to S106 of FIG. 9 and the process from S200 to S206 of FIG. 12 are the same. It is possible to determine, in S102 or in S202, whether the passenger enters the country for the first time (no search results found) or for the second or subsequent time (history of search results found). Based on the determination result, it is possible to perform the process of S104 and subsequent steps for the first entry, and perform the process of S204 and the subsequent steps for the second or subsequent entry. Here, “no search results found” is determined as the first entry. For this reason, if the previous (or present) entry is invalid, it may be determined to be first entry.

The immigration server 10 transmits the ID information received in S200, the checked ID information watch list update serial number (1000 in the example of FIG. 6) included in the immigration history received in S202, and a watch list matching request to the ID information matching server 20 (S208). The ID information matching server 20 searches from the data with numbers larger than the checked update serial number received in the ID information watch list 51. Then, the ID information matching server 20 responds to the immigration server 10 with the result (S210). The immigration server 10 transmits the result to the simplified immigration client terminal 70 (S212). Then, the simplified immigration client terminal 70 displays the received result (S214).

The process of S210 is limited to the updated watch lists with numbers larger than the checked update serial number, namely, the difference watch lists. Thus, in general, the process time is shorter than the time of the process of S110.

Note that in the process from S208 to S214, the matching is performed with the difference ID information watch list, and then the result is displayed. However, it is also possible to perform the process from S108 to S114, instead of the process from S208 to S214, according to the selection of the operator of the simplified immigration client terminal 70. In this way, even for the second or subsequent entry, it is possible to perform watch list check including the ID information other than the difference, according to the operator's will.

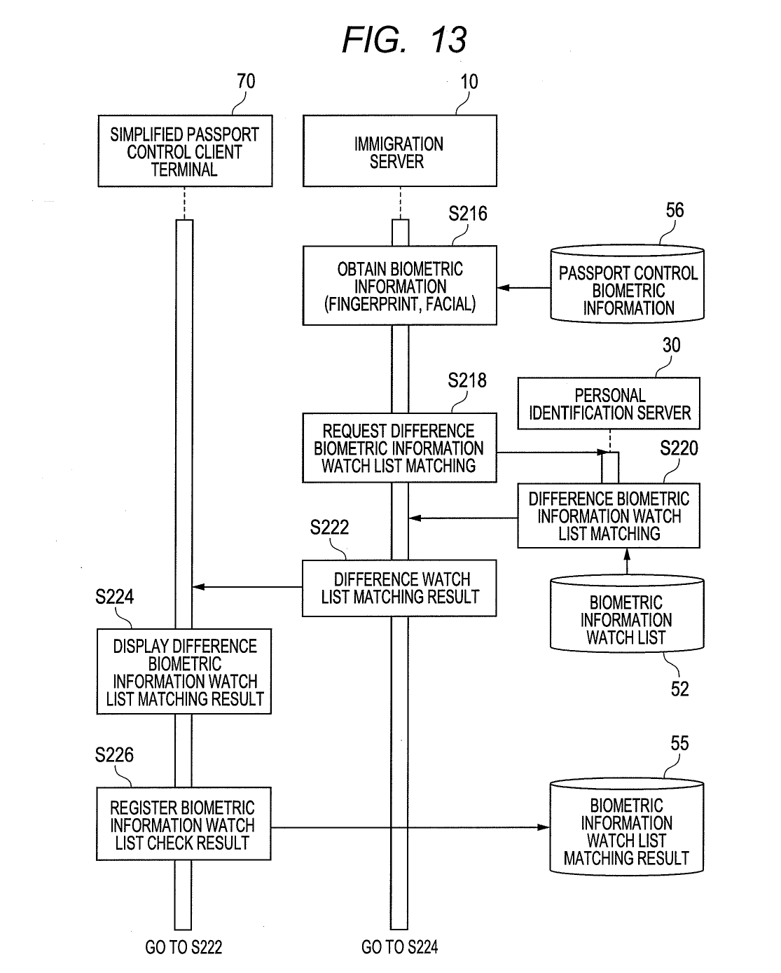

Next, the simplified immigration process (part 2) will be described with reference to the sequence of FIG. 13.

The immigration server 10 obtains the fingerprint and facial information (563 & 5600) for the previous entry from the immigration biometric information 56 (S216).

The immigration server 10 transmits the fingerprint and facial information obtained in S216, the checked biometric information watch list update serial number (2000) included in the immigration history received in S202, and a watch list matching request to the personal identification server 30 (S218). The personal identification server 30 compares the received data, with the data with numbers larger than the checked update serial number received from the immigration server 10. Then, the personal identification server 30 responds to the immigration server 10 with the result (S220). The immigration server 10 transmits the result to the simplified immigration client terminal 70 (S222). Then, the simplified immigration client terminal 70 displays the received result (S224).

The process of S220 is limited to the updated watch lists with numbers lager than the checked update serial number, namely, the difference watch lists. Thus, the process time is shorter than the time of the process of S110.

Note that in the process from S218 to S224, the matching is performed with the difference biometric information watch lists, and then the result is displayed. However, it is also possible to perform the process from S122 to S126, instead of the process from S218 to S224, according to the selection of the operator of the simplified immigration client terminal 70. In this way, even for the second or subsequent entry, it is possible to perform watch list check including the ID information other than the difference, according to the operator's will.

The operator of the simplified immigration client terminal 70 determines whether the passenger is relevant to the biometric information watch list based on the information displayed in S224. Then, the operator inputs the determination result in the simplified immigration client terminal 70. In response to the input from the operator, the simplified immigration client terminal 70 records the determination result in the column (for example, 553 & 5501) of the biometric information watch list matching result 55 corresponding to the passenger identification number and the immigration history ID for the present inspection. Further, the simplified immigration client terminal 70 also records the maximum value of the checked biometric information watch list update serial number in the data that is checked in S220, into the column (554 & 5501) corresponding to the passenger identification number and the immigration history ID for the present inspection (S226).

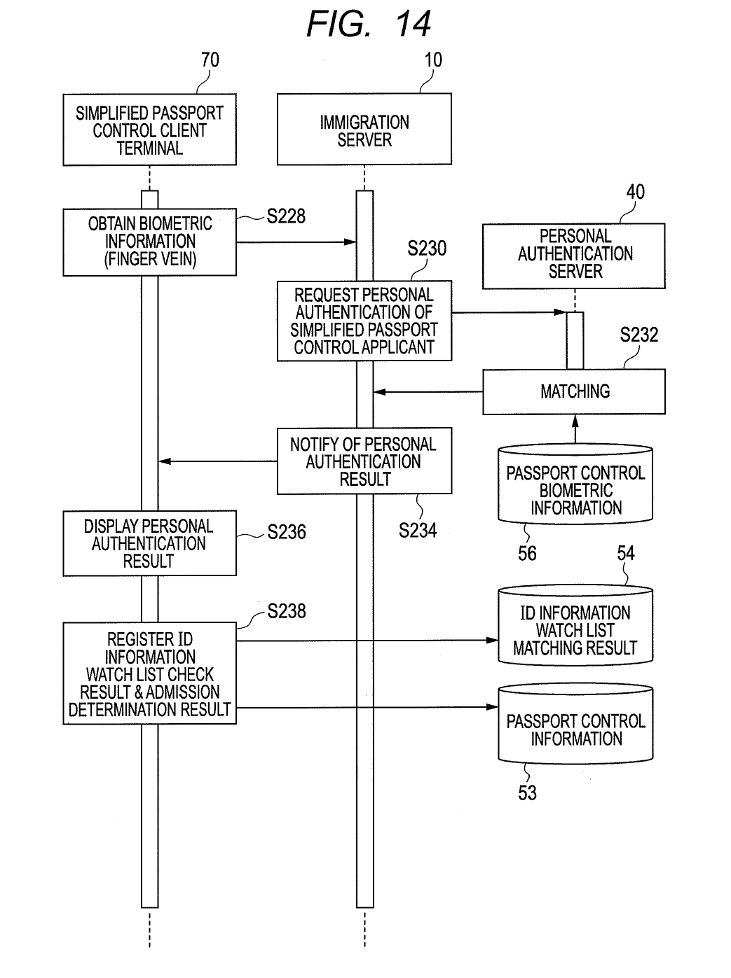

Next, the simplified immigration process (part 3) will be described with reference to the sequence of FIG. 14.

The simplified immigration client terminal 70 obtains the finger vein information by using a part of the finger vein & fingerprint & facial biometric information acquisition function 610. Then, the simplified immigration client terminal 70 transmits the finger vein information to the immigration server 10 (S228).

The immigration server 10 requests the verification server 40 to determine whether the passenger from whom the finger vein information has been obtained in S228 is identical to the person who is registered in the immigration information 53 (personal authentication) (S230). Note that in S230, the immigration server 10 transmits the request, together with the ID information received in S200 as well as the finger vein information received in S228.

The verification server 40 identifies the passenger identification number (Pssenger_0001 in FIG. 4) that matches the ID information received in S230. Then, the verification server 40 obtains the corresponding biometric information (563 & 5600 of the immigration biometric information 56). The verification server 40 compares the finger vein information received in S230 with the finger vein information registered in 563 & 5600, to determine whether the two finger vein information pieces are of the same person. Then, the verification server 40 responds to the immigration server 10 with the result (S232). In S232, if it is determined that the received biometric information and the registered biometric information are not of the same person, the verification server 40 responds to the immigration sever 10 with a result of authentication NG. If it is determined that these biometric information pieces are of the same person, the verification server 40 responds to the immigration server 10 with a result of authentication OK. The immigration server 10 notifies the simplified immigration client terminal 70 of the result (S234). Then, the simplified immigration client terminal 70 displays the notified result (S236).

Note that a series of processes from S228 to S236 can be performed with either one of finger vein, fingerprint, and facial image, or in a combination of such biometric information. When the matching is performed using a combination of a plurality of types of biometric information (for example, fingerprint and finger vein), one or both of the following effects can be achieved. (1) More accurate matching can be achieved. (2) When it is difficult to obtain one (for example, fingerprint) of the two types of biometric information of the passenger due to the environmental influence or the personal characteristics, the other biometric information (for example, finger vein) can be used for the matching to reduce the number of cases unable to perform matching.

Note that a series of processes from S228 to S236 can be performed using finger vein, fingerprint, or facial image. In this case, the authentication accuracy is higher in the order of finger vein, fingerprint, and facial image, making it possible to achieve the effect of preventing impersonation. For example, it is possible to keep “strictness” of immigration by using the finger vein information.

Note that a series of processes from S228 to S236 may be performed between S226 and S238 as described in this embodiment, or may be performed between S200 and S220 at an arbitrary timing. When the processes are performed between S226 and S238, then the simplified immigration passenger to be examined personal authentication is performed after the difference ID information watch list matching result display and after the difference biometric information matching result display. Thus, it is possible to explicitly indicate the order of the control process (1. watch list matching, and 2. personal authentication) to the operator of the simplified immigration client terminal 70.

The operator of the simplified immigration client terminal 70 determines whether the passenger is relevant to the watch list based on the information displayed in S236. Further, the operator determines whether entry permission is granted, from a comprehensive perspective by taking into account the other inspection operation. Then, based on the input content according to the determination, the simplified immigration client terminal 70 performs the following steps:

(1) Record the determination result in the column (543 & 5401) of the ID information watch list matching result 54 corresponding to the passenger identification number and the immigration history ID for the present inspection;
(2) Record the maximum value of the checked ID information watch list update serial number in the data that is checked in S210, into the column (544 & 5401) of the ID information watch list matching result 54 corresponding to the passenger identification number and the immigration history ID for the present inspection; and
(3) Record the simplified entry permission determination result in the column (534 & 5302) of the immigration information 53 corresponding to the passenger identification number and the immigration history ID for the present inspection (S238).

Note that when the operator of the simplified immigration client terminal 70 determines “entry not permitted” in the process of S238, it is possible to perform the flow of normal immigration from FIG. 9 to FIG. 11 according to the instruction of the operator. It is also possible to perform the flow of normal immigration by omitting a part of the processes from FIG. 9 to FIG. 11 (for example, omitting the steps from S108 to S114).

Note that in the processes from FIG. 12 to FIG. 14, some of the processes from FIG. 9 to FIG. 11 are omitted, but are not necessarily omitted. For example, it is possible to perform the process from S108 to S114 instead of the process from S208 to S214, or perform the process of S116 and S118 instead of the process of S216, or perform the process from S122 to S126 instead of the process from S218 to S224, or perform the process from S130 to S132 between S236 and S238, or perform the process of S136 after S238.

FIG. 15 shows an example of a screen displayed in the normal immigration client terminal 60 in the sequence from FIG. 9 to FIG. 11.

The normal immigration client terminal 60 displays an immigration history 6004 in S106, an ID information watch list matching result 6000 in S114, and a biometric information watch list matching result 6002 in S126.

Note that the immigration history 6004 of FIG. 15 can be displayed from the latest history to the oldest one in the descending order. In this way, the operator can easily check the latest history.

Note that the immigration history 6004 of FIG. 15 may or may not be displayed.

FIG. 16 is an example of a screen displayed in the simplified immigration client terminal 70 in the sequence from FIG. 12 to FIG. 14.

The simplified immigration client terminal 70 displays an immigration history 7006 in S206, a difference ID information watch list matching result 7000 in S214, and a difference biometric information watch list matching result 7002 in S224. Further, in S236, the simplified immigration client terminal 70 displays “personal identity check OK” based on the personal authentication result notification received in S234. Then, the simplified immigration client terminal 70 summarizes the immigration history (for example, 534 & 5300) received in S206, and displays “previous immigration cleared”.

Note that the immigration history 7006 of FIG. 16 can be displayed from the latest history to the oldest one in the descending order. In this way, the operator can check the latest history at a glance.

Note that the immigration history 7006 of FIG. 16 may or may not be displayed.

Further, in the immigration history 7006 of FIG. 16, the corresponding facial image can also be displayed by reading from the biometric information 563 of the immigration biometric information 56. In this way, the immigration officer can verify the identity of the passenger to be examined by comparing the face of the passenger to be examined with the facial image. Thus, reliable personal identity verification can be achieved.

According to the present embodiment, the following effects can be achieved. The first effect is as follows.

In the process of the normal immigration in FIG. 9, the matching with the ID information watch list is performed in S110. When the number of watch lists to be compared is large, the response time of S108 increases. On the other hand, in the process of the simplified immigration, in S210, the matching is performed with the difference, namely, a part of the ID information watch list, so that the response time of S208 is reduced. This can contribute to speeding up the immigration process.

The second effect is as follows.

In the process of the normal immigration in FIG. 10, the matching is performed with the biometric information watch list in S124. When the number of watch lists to be compared is large, the response time of S122 increases. On the other hand, in the process of the simplified immigration, in S220, the matching is performed with the difference, namely, a part of the biometric information watch list, so that the response time of S218 is reduced. This can contribute to speeding up the immigration process.

The third effect is as follows.

In the process of the normal immigration in FIG. 9, the result of matching with the ID information watch list is displayed in S114. When the number of matching results is large, the operator of the normal immigration client terminal 60 should take a long time to check the matching results. However, in the process of the simplified immigration in FIG. 12, in S214, the result of matching with the difference, namely, a part of the ID information watch list is displayed. In other words, a smaller number of matching results is displayed (comparing 6000 of FIG. 15 with 7000 of FIG. 16). As a result, the operator of the simplified immigration client terminal 70 can check the matching results in a short time. This can contribute to speeding up the immigration process. Further, in simplified immigration, if much time has not passed after the previous travel, the number of displayed results is expected to be reduced as shown in the example of FIG. 16. This leads to an increase in the effect of speeding up the immigration process with respect to the person who often enters the country.

The fourth effect is as follows.

In the process of the normal immigration in FIG. 10, the result of matching with the biometric information watch lists is displayed. When the number of matching results is large, the operator of the normal immigration client terminal 60 should take a long time to check the matching results. However, in the process of the simplified immigration in FIG. 13, in S224, the result of matching with the difference, namely, a part of the biometric information watch list is displayed. Thus, a smaller number of matching results is displayed (comparing 6002 of FIG. 15 with 7002 of FIG. 16). As a result, the operator of the simplified immigration client terminal 70 can check the matching results in a short time. This can contribute to speeding up the immigration process. Further, in simplified immigration, if much time has not passed after the previous travel, the number of displayed results is reduced as shown in the example of FIG. 16. As a result, the effect of speeding up the immigration process increases with respect to the person who often enters the country.

The fifth effect is as follows.

In the process of the normal immigration in FIG. 10, the biometric information (fingerprint) is obtained in S116 and the biometric information (facial) obtained in S118, so that the process takes time. The obtained information is used in the processes from S122 to S126. On the other hand, in the process of the simplified immigration, the information is obtained from the database in S216 without performing S116 and S118. Thus, the process takes only a short time. Note that the biometric information (finger vein) is obtained in S116 in the normal immigration, and the biometric information (finger vein) is obtained in S228 in the simplified immigration. For this reason, a time reduction is not expected with respect to the biometric information (finger vein).

### Second Embodiment

A second embodiment is an example of performing a simplified immigration process. The second embodiment is different from the first embodiment in that ID information and biometric information are obtained and stored upon registration in the registry office, issuance of a visa in the embassy, departure from the country, and issuance of a resident card, instead of the normal immigration from FIG. 9 to FIG. 11 in the first embodiment. Then, in the simplified immigration process, ID information and biometric information are obtained again upon entry into the country to compare with the stored information. In the present application, as described above, the first and second embodiments are separated according to the venue. However, the processes of FIG. 9 and FIG. 12, the processes of FIG. 10 and FIG. 13, or the processes of FIG. 11 and FIG. 14 may be treated as one group, by taking into account the commonality of the matching (authentication) process between the normal immigration and the simplified immigration.

In this embodiment, a terminal having the function of the normal immigration client terminal 60 in FIGS. 1 and 2 is provided in the embassy that issues visas, the immigration booth, or the residence card counter. The system configuration other than the normal immigration client terminal 60 is the same as the system configuration of FIGS. 1 and 2.

Also, the ID information watch list 51 of FIG. 3 and the biometric information watch list 52 of FIG. 4 are the same as those of the first embodiment.

In the immigration history of FIG. 5, “entry cleared” shown in FIG. 5 can be replaced with “registration cleared” for the registration in the registry office, “visa application cleared” for the issuance of a visa in the embassy, “departure immigration cleared” for the departure from the country, and “residence card application cleared” for the issuance of a residence card.

In this embodiment, the processes from FIG. 9 to FIG. 11 are performed by the terminal having the function of the normal immigration client terminal 60, which is provided in the embassy that issues visas, the departure immigration booth, and the residence card counter, instead of the normal immigration client terminal 60. The terminal having the function of the normal immigration client terminal 60 performs the processes from S100 to S128 in FIGS. 9 to 11. Then, the terminal registers the result in the ID information watch list matching result 54 in S134. At the same time, the terminal records “visa application cleared” for the issuance of a visa in the embassy, “departure application cleared” for the departure from the country, and “residence card application cleared” for the issuance of a residence card, into the immigration history 534 of the immigration information 53.

Also in this embodiment, similarly to the first embodiment, the simplified immigration flow from FIG. 12 to FIG. 14 is performed, upon entry into the country after the processes from FIG. 9 to FIG. 11 are completed.

The effects of this embodiment are the same as the first to fifth effects of the first embodiment.

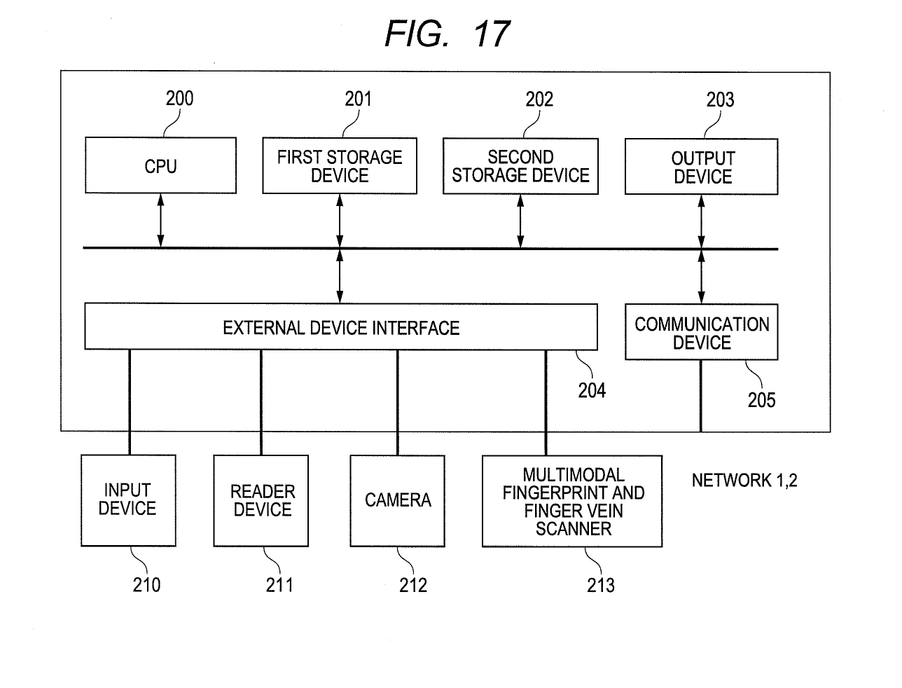

FIG. 17 shows the main hardware configuration of the devices constituting the immigration system in the first and second embodiments.

Each component of the immigration system is realized by a general-purpose computer including a CPU and a storage device. Further, the function of each component is embodied in the computer by the CPU when executing a program stored in the storage device. Each program may be stored in advance in the storage device within the computer, or may be loaded in the storage device from another device through an input/output interface as well as a medium that can be used by the computer. For example, the medium is a storage medium removable from the input/output interface, or a communication medium (namely, a wired, wireless, or optical network, or a carrier wave or digital signal that propagates through the network).

In the first and second embodiments, the immigration server 10, the ID information matching server 20, the personal identification server 30, the verification server 40, the normal immigration client terminal 60, and the simplified immigration client terminal 70 respectively have a primary structural unit of the hardware configuration shown in FIG. 17. In other words, the main server includes a CPU 200, a first storage device 201, a second storage device 202, an output device 203, a communication device 205, and an external device interface 20. With respect to the terminal devices, the normal immigration client terminal 60 and the simplified immigration client terminal 70 include an input device 210, a reader device 211 (such as passport information reader, ID card reader, or bar code reader), a camera 212, and a multimodal fingerprint and finger vein scanner 213.

For example, the immigration operation function 11 of the immigration server 10, the ID information watch list matching function 21 of the ID information matching server 20, the biometric information watch list matching function 31 of the personal identification server 30, the simplified immigration passenger to be examined matching function 41 of the verification server 40 are all realized by reading the data of the second storage device 202 and by computing the data by the CPU 200.

The ID information watch list 51, the biometric information watch list 52, the immigration information 53, the ID information watch list matching result 54, the biometric information watch list matching result 55, and the immigration biometric information 56 are all realized by storing the DB in the second storage device 202, respectively.

The ID information acquisition function 602 of the normal immigration client terminal 60 and the simplified immigration client terminal 70 is realized by reading the data obtained by the reader device 211 into the first storage device 201, reading the data of the second storage device 202 into the first storage device 201, and computing the data by the CPU 200.

It is to be noted that the present invention is not limited to the exemplary embodiments, and may include various modifications and alternative forms. For example, the forgoing descriptions of the specific embodiments are presented for illustration and description. They are not intended to be exhaustive or to limit the invention to the precise forms disclosed. Further, a part of the configuration of one embodiment can be replaced by the configuration of the other embodiment, or the configuration of one embodiment can include the configuration of the other embodiment. Further, the other configuration can be added, deleted, or replaced with respect to a part of the configuration of each embodiment.

According to the embodiments described above, even if the number of registrations in the watch list database is large, a small amount of similar watch list information is displayed as the matching results. Thus, it is possible to reduce the time for checking the results by the operator. Further, it is also possible to reduce the time for the entire immigration process including the watch list matching result display.

What is claimed is:

1. An immigration system comprising:
a immigration information DB for storing immigration information obtained by a first terminal, including ID information for identifying a user as well as biometric information of the user;
a watch list database for storing watch list information;
a matching server that allows first immigration by comparing the immigration information with the watch list information of the watch list database;
the first terminal for displaying a result of comparing with watch lists;
a verification server having a simplified immigration passenger to be examined matching function that compares the biometric information in the immigration information DB with biometric information obtained by a second terminal, to determine whether these biometric information pieces are of the same person; and
an immigration server for controlling the immigration operation,
wherein in the first immigration, the immigration server receives first biometric information of an passenger to be examined by the first terminal, and stores the first biometric information in the immigration information DB,
wherein the matching server compares the first biometric information with first watch list information,
wherein the first terminal displays a result of comparing the first biometric information with the first watch list information, and
wherein, in the subsequent second immigration, the verification server compares the first biometric information in the immigration information DB with second biometric information obtained by the second terminal.

2. The immigration system according to claim 1,
wherein the matching server compares the first biometric information with the second watch list information other than the first watch list information in the watch list database, and
wherein the second terminal displays a result of comparing with the second watch list information.

3. The immigration system according to claim 1,
wherein the watch list information includes:
ID information watch list information including ID information that identifies users who satisfy a predetermined condition; and
a biometric information watch list including biometric information of the users who satisfy the predetermined condition.

4. An immigration system comprising:
a immigration information DB for storing immigration information obtained by a first terminal, including ID Information for identifying a user as well as biometric information of the user;
a watch list database for storing watch list information;
a matching server for comparing the immigration information with the watch list information of the watch list database;
the first terminal for displaying a result of comparing with watch lists;
a verification server having a simplified immigration passenger to be examined matching function that compares the biometric information in the immigration information DB with biometric information obtained by a second terminal, to determine whether these biometric information pieces are of the same person; and
an immigration server for controlling the immigration operation,
wherein in the first immigration, the immigration server stores the first biometric information and third biometric information, which are input from the passenger to be examined, into the immigration information DB,
wherein the matching server compares the third biometric information with the watch list information,
wherein the first terminal displays a result of comparing the third biometric information with the watch list information,
wherein, in the subsequent second immigration, the verification server compares the first biometric information in the immigration information DB with second biometric information obtained by the second terminal,
wherein the matching server compares the third biometric information stored in the immigration information DB in the first immigration with the watch list information, and
wherein the second terminal displays a result of comparing the third biometric information with the watch list information.

5. The immigration system according to claim 1,
wherein the first biometric information and the second biometric information each include at least finger vein information.

6. An immigration system for controlling immigration, comprising:
checking the presence of a previous immigration result of an passenger to be examined in the immigration control;
when the immigration result is present, checking the immigration result to determine whether the particular immigration result satisfies a predetermined condition;
when the immigration result satisfies the predetermined condition, identifying the personal information of the passenger to be examined that is used in the check of the particular immigration result; and
comparing the identified personal information with the personal information input from the passenger to be examined, to determine the identity of the passenger to be examined.

7. The immigration system according to claim 6,
wherein the personal information is biometric information of the passenger to be examined.
